(19) United States
(12) Patent Application Publication
(10) Pub. No.: US 2011/0316670 A1
(43) Pub. Date: Dec. 29, 2011

(54) BIOMETRIC KIT AND METHOD OF CREATING THE SAME

(76) Inventor: Matthew T. Schwarz, Davenport, IA (US)

(21) Appl. No.: 12/824,317

(22) Filed: Jun. 28, 2010

(51) Int. Cl. G06F 7/04; G06K 9/00

(52) U.S. Cl. 340/5.82; 382/118

(57) ABSTRACT

A biometric kit and method of using the same includes the collection and verification of photographs, friction ridge detail, DNA profile, and dental radiographs of an individual along with a personal information profile. The collected and verified data is converted to a digital format and stored

### BACKGROUND OF THE INVENTION

This invention is directed toward the collection and use of biometric information, and more particularly to the creation of a biometric kit for use in the timely identification of individuals.

Organizations, particularly those having a global reach, face difficult and serious issues concerning the safety of employees due to aircraft crashes, natural disasters, kidnapping, and terrorism. In each scenario, based on current practices, it is difficult to properly identify individuals so that they can be returned to next of kin, insurance claims can be processed, and estates can be settled.

Typically, due to the severity of the accident, there is little information by which to identify a victim as identification documents are missing and due to injuries or decomposition, standard identification methods are not available. Currently, most identification information is gathered after the fact. For example, DNA samples are gathered from toothbrushes, hairbrushes or relatives. A search for fingerprints is conducted from previous background checks or police records. Also, family photos. The reliability of these methods not only is suspect, but also is time consuming sometimes taking months to perform. Accordingly, there exists a need in the art for a biometric kit and method of using the same that addresses these deficiencies.

An objective of the present invention is to provide a more reliable way to identify the remains of an individual.

These and other objectives will be apparent to one skilled in the art based upon the following disclosure.

### SUMMARY OF THE INVENTION

A biometric kit and method of using the same includes the collection and verification of photographs, friction ridge detail, DNA profile, and dental radiographs of an individual along with a personal information profile. The collected and verified data is converted to a digital format and stored.

### BRIEF DESCRIPTION OF THE DRAWINGS

FIG. 1 is a schematic drawing of the environment of a biometric kit; and

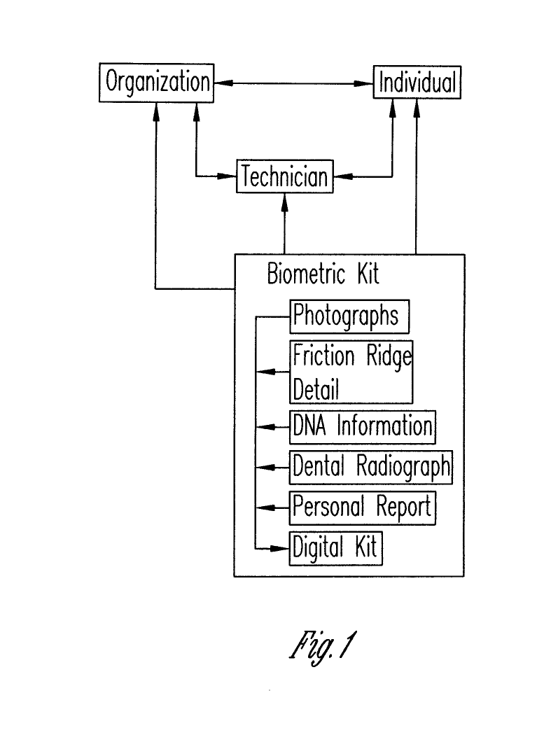

FIG. 2 is a flow diagram of a method of creating a biometric kit.

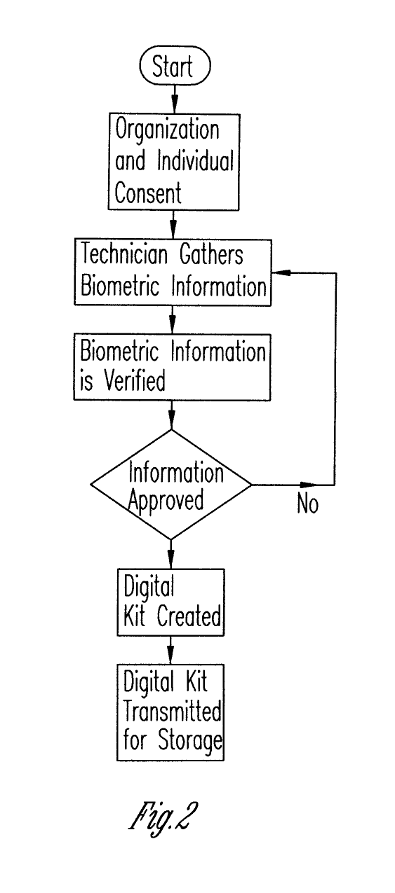

### DETAILED DESCRIPTION OF THE PREFERRED EMBODIMENTS

Referring to the Figures, the biometric kit includes photographs 12, friction ridge detail collection 14, a DNA profile 16, a dental radiograph 18, and a record of personal information 20.

The photographs 12 will include both facial 22 and identifiers 24 such as scars, marks, and tattoos. Preferably the facial photographs 22 will include a frontal, left and right side with a name tag and scale. These photographs will be taken in RAW format to maximize the information contained in each image and allow for subsequent forensic use of the image. Photos will be taken in accordance with the standards promulgated by the American National Standards Institute and the National Institute of Science and Technology. All photographs will be suitable for use with state of the art photo recognition software. Identifier photographs 24 will be taken with a name tag and scale. In addition, all identifying marks will be documented and charted by a technician 26.

Friction ridge detail collection 14 includes information on fingers, palms, joint tips and footprints. This information is collected in a manner known as friction ridge detail. For example finger print cards (known as 10 print) as well as inked impression of friction skin on the sides of the fingers (known as major case prints) are taken. Powder and tape lifts of all friction ridge skin on the hands may also be taken. Finally, inked and/or powder and tape lifts of all friction ridge skin on the feet are taken. Advanced friction skin ridge may also be collected by taking a cast of the hands and/or feet using preferably a silicone material such as polyvinylsiloxane. The cast creates a negative mold of the friction skin which can be used to create an exact positive replica of the friction skin. The cast is the most complete method to document friction skin and allow for additional chances of identification of an unknown print beyond the two dimensional records.

The DNA profile 16 includes a buccal swab taken from the individual's mouth. The swab is sent to a DNA lab for a profile to be developed and included in the kit. The DNA profile is designed to remove human genome information so the profile cannot be used for identification of future medical issues. The swab is destroyed during processing and only the DNA profile will be retained in a written, PDF or similar format for easy storage.

The dental radiograph 18 is obtained from the individual's dentist or will be taken by a technician. Preferred is an x-ray of the whole mouth. From the x-rays and dental records a 1-32 standard dental mapping is included in the written records. The x-rays and written record are converted to an electronic file.

Finally, the record of personal information 20 is based upon the Victim Identification Profile shown in the National Association of Medical Examination Mass Fatality Plan. Included is information from a survey completed by the individual with duress/identification codes used in kidnapping scenarios and identification information and serial numbers for medical devices such as pacemakers or artificial joints.

In operation, initially the organization and the individual consent to having a kit 10 prepared. Once consent is received a technician 26 meets with the individual and collects the biometric information and personal information. Once collected, the biometric/forensic data is verified by a subject matter expert. For example, a certified latent print examiner checks all friction ridge detail to ensure suitability for identification. Any questionable impressions will be retaken. Similarly, a board certified and licensed dentist will verify the suitability of all radiographs. Further, all documents generated during the information gathering process will have a thumbprint of the subject to guarantee reliability and accuracy of the information generated.

Once the information is gathered from the individual, the information is converted into a digital format. High resolution scans are made of all friction ridge skin and the documents generated during collection. Lower resolution copies are also prepared in the event the kit needs to be e-mailed. Preferably the digital kit is encrypted and recorded to archival quality optical and/or magnetic media.

Once the digital kit is created it is transmitted over an electronic network for storage. Depending on the consent, the digital kit is stored by the organization, the individual, and/or the technician. Physical items such as silicone casts are placed in archival quality storage containers.

Accordingly, a biometric kit has been disclosed that at the very least meets the stated objectives.

What is claimed is:

1. A biometric kit, comprising:
photographs of an individual's face and identifying marks;
friction ridge detail of the individuals hands and feet;
a DNA profile;
a dental radiograph; and
a personal information record wherein the photographs, friction ridge detail, DNA profile and personal information record are stored in a digital format.

2. The kit of claim 1 wherein the kit includes a cast of the individual's hands and feet.

3. A method of creating a biometric kit, comprising the steps of:
obtaining consent from an organization and an individual;
collecting biometric information by a technician,
verifying the biometric information with a subject matter expert;
converting the biometric information to a digital format;
storing the digital biometric information.
